(19) United States
(12) Patent Application Publication
(10) Pub. No.: US 2012/0162225 A1
(43) Pub. Date: Jun. 28, 2012

(54) VIEW DEPENDENT TECHNIQUES TO DETERMINE USER INTEREST IN A FEATURE IN A 3D APPLICATION

(75) Inventors: Po-Feng Paul Yang, Sunnyvale, CA (US); Brian Edmond Brewington, Fort Collins, CO (US); Charles Chapin, San Jose, CA (US); James Anthony Guggemos, Windsor, CO (US); Dale Hawkins, Erie, CO (US); Mark Limber, Boulder, CO (US); Mihai Mudure, San Jose, CA (US); Bryce Stout, Boulder, CO (US); Xinyu Tang, Cupertino, CA (US)

(73) Assignee: Google Inc., Mountain View, CA (US)

(21) Appl. No.: 12/977,316

(22) Filed: Dec. 23, 2010

(51) Int. Cl. G06T 17/00

(52) U.S. Cl. 345/420

(57) ABSTRACT

Aspects of the invention relate generally determining user interests and providing relevant information based on user interaction with 3D models. More specifically, a when a user interacts with a 3D model of an object, for example on a map or from a database of models, the user's view of the object along with the location of the interaction (or where the user clicked on the object) may be transmitted to a server. In response, based on the view and location of the click, the server identifies relevant content and transmits it to the user.

### BACKGROUND OF THE INVENTION

Various Internet-based services allow users to view and interact with maps including three-dimensional (“3D”) models of various objects such as buildings, stadiums, roadways, and other topographical features. For example, a user may query the service for a map of a location. In response, the server may receive a map with various three-dimensional features. The user may select a 3D model, in order to get more information or interact with the model, for example by clicking, grabbing, or hovering over with a mouse or pointer, pinching, etc.

Some services allow users to upload and share three-dimensional (“3D”) models of various objects such as the interior or exterior of buildings, stadiums, ships, vehicles, lakes, trees, etc. The objects may be associated with various types of information such as titles, descriptive data, user reviews, points of interest (“POI”), business listings, etc. Many of the objects and the models themselves, such as buildings, may be geolocated or associated with a geographic location such as an address or geolocation coordinates. Models may also be categorized. For example, a model of a sky scraper may be associated with one or more categories such as sky scrapers, buildings in a particular city, etc. In this regard, a user may search the database for models, for example, based on the associated title, geographic location, description, object type, collection, physical features, etc.

These 3D applications may include highly detailed geometrical representations of 3D objects; however, they may be unable to keep specific information about a particular feature within the object. When the user interacts with an object, the service may only be able to treat the object as a whole and react very generally. In other words, interacting at different points on the object would have the same result; the same additional information may be shown or the user may be linked to the same web page. This may lead to a less engaging user experience and missed monetization opportunities.

### BRIEF SUMMARY OF THE INVENTION

Aspects of the invention relate generally determining user interests and providing relevant information based on user interaction with 3D models. More specifically, when a user interacts with a 3D model of an object, for example on a map or from a database of models, the user's view of the object along with the location of the interaction (or where the user clicked on the object) may be transmitted to a server. In response, based on the view and location of the click, the server identifies relevant content and transmits it to the user.

One aspect of the invention provides a computer-implemented method for providing content for display to a user. The method includes identifying a 3D model of an object associated with geolocation information and dimensional information; receiving, from a client device, information identifying a user action and a location of the user action on the 3D model; determining, by a processor, a geographic location based on the location of the user action on the 3D model, the geolocation information and the dimensional information; identifying content based on the geographic location; and transmitting the content to the client device for presentation to the user.

In one example, the object is a building. In another example, the information identifying a user action is a click on the 3D model. In another example, the geographic location is a section of the 3D model or the object and the content is identified based on the section. In another example, the content is an advertisement. In another example, the information identifying the location of the user action includes a orientation of the 3D model at a time of the user action. In another example, the geolocation information includes position coordinates and the dimension information includes one or more of height, width, and depth information of the object. In another example, the method also includes in response to receiving the information identifying a user action, transmitting a request for user input; receiving the user input; and storing the user input with other received input in memory accessible by the processor. In one alternative, the content is identified based on the other received input. In another alternative, the method also includes using the stored user input and the other received input to divide the 3D model or the object into two or more sections; and identifying a section of the two or more sections based on the received information identifying a user action and a location of the user action on the 3D model; wherein identifying the content is further based on the identified section.

Another aspect of the invention provides a computer. The computer includes a processor and memory accessible by the processor. The processor is operable to identify a 3D model of an object associated with geolocation information and dimensional information; receive, from a client device, information identifying a user action and a location of the user action on the 3D model; determine a geographic location based on the location of the user action on the 3D model, the geolocation information and the dimensional information; identify content based on the geographic location; and transmit the content to the client device for presentation to the user.

In one example, the object is a building. In another example, the information identifying a user action is a click on the 3D model. In another example, the geographic location is a section of the 3D model or the object and the content is identified based on the section. In another example, the content is an advertisement. In another example, the information identifying the location of the user action includes an orientation of the 3D model at a time of the user action. In another example, the geolocation information includes position coordinates and the dimension information includes one or more of height, width, and depth information of the object. In another example, the processor is also operable to in response to receiving the information identifying a user action, transmit a request for user input; receive the user input; and store the user input with other received input in memory accessible by the processor. In one alternative, the content is identified based on the other received input. In another alternative, the processor is also operable to use the stored user input and the other received input to divide the 3D model or the object into two or more sections; and identify a section of the two or more sections based on the received information identifying a user action and a location of the user action on the 3D model; and the content is identified based on the identified section.

### BRIEF DESCRIPTION OF THE DRAWINGS

FIG. 1 is a functional diagram of a system in accordance with an aspect of the invention.

FIG. 2 is a pictorial diagram of the system of FIG. 1.

FIG. 3 is an exemplary screen shot in accordance with an aspect of the invention.

FIG. 4 is another exemplary screen shot in accordance with an aspect of the invention.

FIG. 5 is a further exemplary screen shot in accordance with an aspect of the invention.

FIG. 6 is an exemplary 3D model in accordance with an aspect of the invention.

FIG. 7 is another exemplary 3D model in accordance with an aspect of the invention.

FIG. 8 is an exemplary flow diagram in accordance with an aspect of the invention.

### DETAILED DESCRIPTION

In one example, content may be provided to users based on their interactions with 3D models. When a user uses a client device to interacts with a particular 3D model, information regarding how the user has interacted with the particular model, for example the location of action such as a click on the 3D model and a view point (such as a camera angle, orientation, and position) of the 3D model, may be transmitted with the user's permission to a server computer. The server may have access to information databases or other storage systems correlating the 3D models to geographic locations and correlating those geographic locations to various types of content, such as advertisements, images, web pages, etc. For example, a geographic location may be determined based on the location of the user action, the geolocation and dimensional information associated with the 3D model, as well as the view point. Content may be identified based on the determined geographic location. The content may then be transmitted to the client device for display to a user.

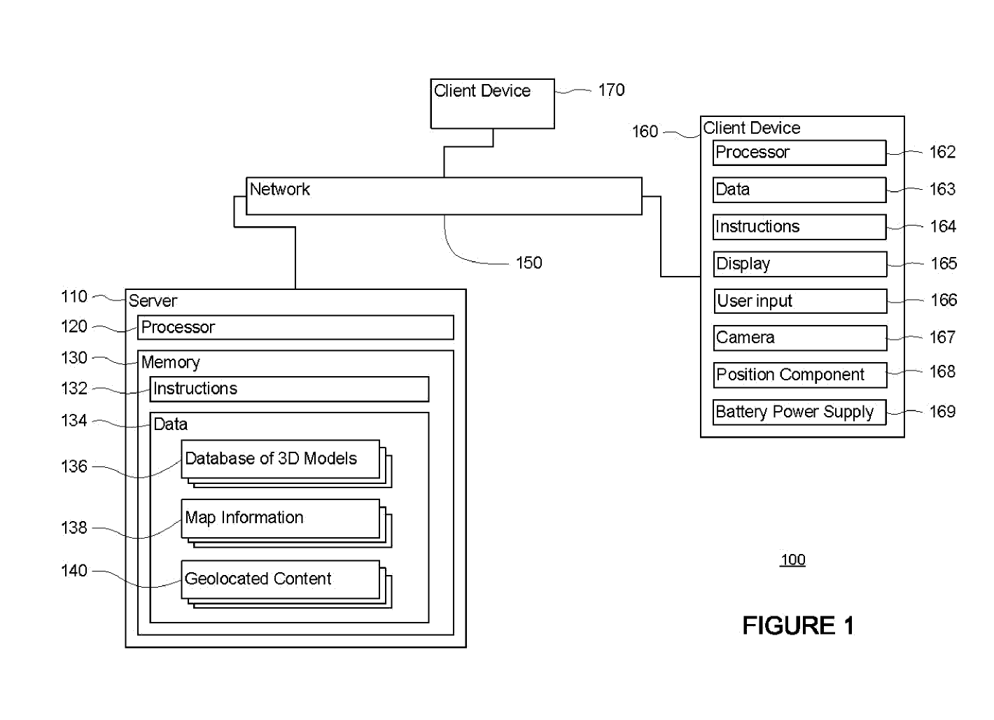

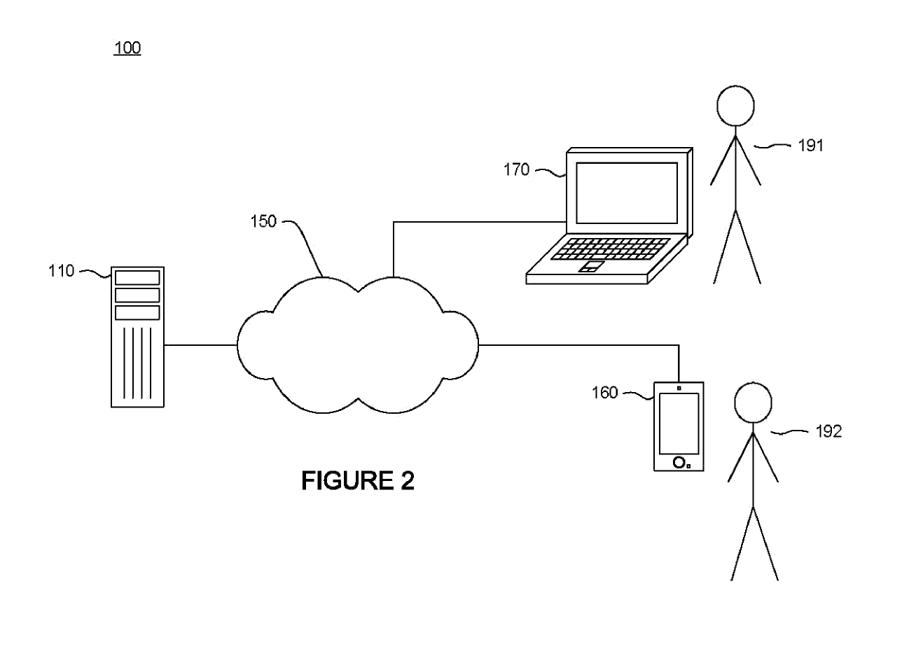

As shown in FIGS. 1-2, a system 100 in accordance with one aspect of the invention includes a computer 110 containing a processor 120, memory 130 and other components typically present in general purpose computers.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods in accordance with aspects of the invention may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as processors from Intel Corporation or Advanced Micro Devices. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor, a computer, or a memory will be understood to include references to a collection of processors, computers, or memories that may or may not operate in parallel.

The computer 110 may be at one node of a network 150 and capable of directly and indirectly receiving data from other nodes of the network. For example, computer 110 may comprise a web server that is capable of receiving data from client devices 160 and 170 via network 150 such that server 110 uses network 150 to transmit and display information to a user on display 165 of client device 170. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

Network 150, and intervening nodes between server 110 and client devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 1-2, it should be appreciated that a typical system can include a large number of connected computers.

Each client device may be configured similarly to the server 110, with a processor, memory and instructions as described above. Each client device 160 or 170 may be a personal computer intended for use by a person 191-192, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or any other electrical device that is operable to display information), end user input 166 (e.g., a mouse, keyboard, touch-screen or microphone). The client device may also include a camera 167, a position component 168, an accelerometer, speakers, a network interface device, a battery power supply 169 or other power source, and all of the components used for connecting these elements to one another.

Although the client devices 160 and 170 may each comprise a full-sized personal computer, they may alternatively comprise mobile devices capable of wirelessly exchanging data, including position information derived from position component 168, with a server over a network such as the Internet. By way of example only, client device 160 may be a wireless-enabled PDA or a cellular phone capable of obtaining information via the Internet. The user may input information using a small keyboard, a keypad, or a touch screen.

The server may also access a database 136 of 3D models of various objects. These 3D objects may be associated with data provided by the model's creator (or uploading user) or other users of the system. For each model, the data may include one or more categories, geographic locations, descriptions, user reviews, etc. The models may be associated with user-designated collections. For example, when a user uploads a new model to the database, the user may designate the model as part of one or more collections, such as “mid-century modern” or “stuff I like,” which associated the new model with other models also associated with the same collection. This information may be used to index and search the database.

The server may also access map information 138. The map information may include highly detailed maps identifying the geographic location of buildings, waterways, POIs, the shape and elevation of roadways, lane lines, intersections, and other features. The POIs may include, for example, businesses (such as retail locations, gas stations, hotels, supermarkets, restaurants, etc.), schools, federal or state government buildings, parks, monuments, etc. In some examples, the map information may also include information about the features themselves, for example, an object's dimensions including altitudes (or heights), widths, lengths, etc. Many of these features may be associated with 3D models such that the map information may be used to display 2D or 3D maps of various locations.

The system and method may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is capable of identifying a geographic locations (e.g., lot and block numbers on survey maps). Moreover, a location may define a range of the foregoing. The systems and methods may further translate locations from one reference system to another. For example, the client 160 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other references systems as well.

The server may also access geolocated content database 140. Content of database 140 may include geolocated advertisements, business listings, coupons, videos, and web pages. For example, an advertisement or coupon may be associated with a particular geographic point or area. In some examples the geographic area or point may be associated with a location relative to an object such as the third floor of an office building or the front door of a restaurant.

Various operations in accordance with aspects of the invention will now be described. It should also be understood that the following operations do not have to be performed in the precise order described below. Rather, various steps can be handled in a different order or simultaneously, and steps may be omitted and/or added.

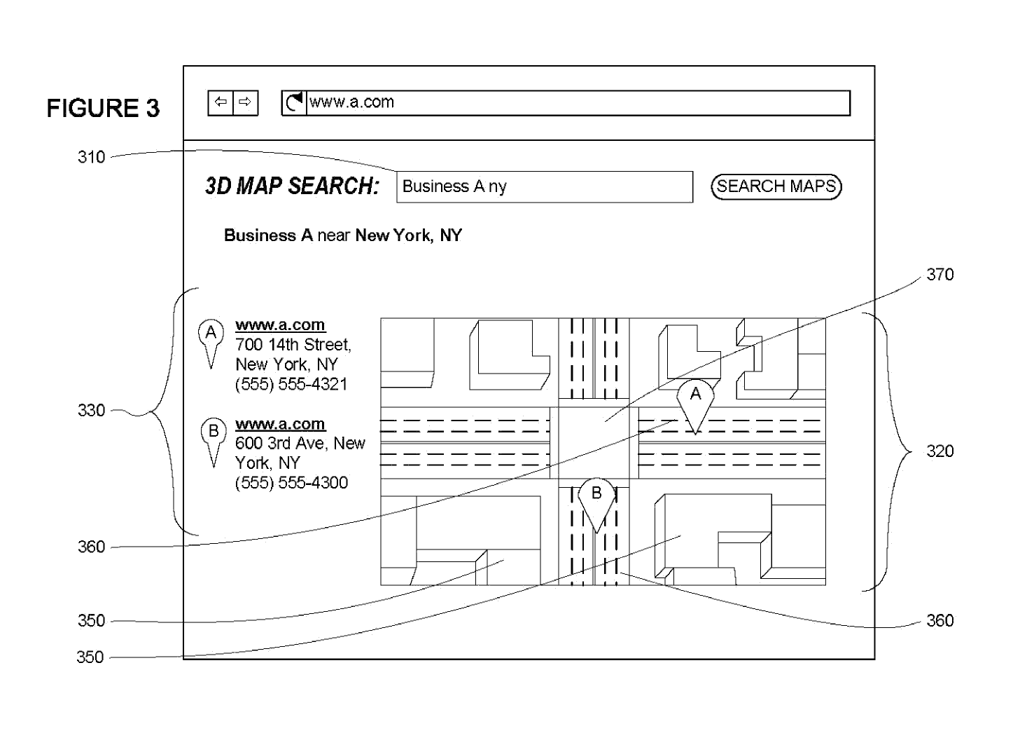

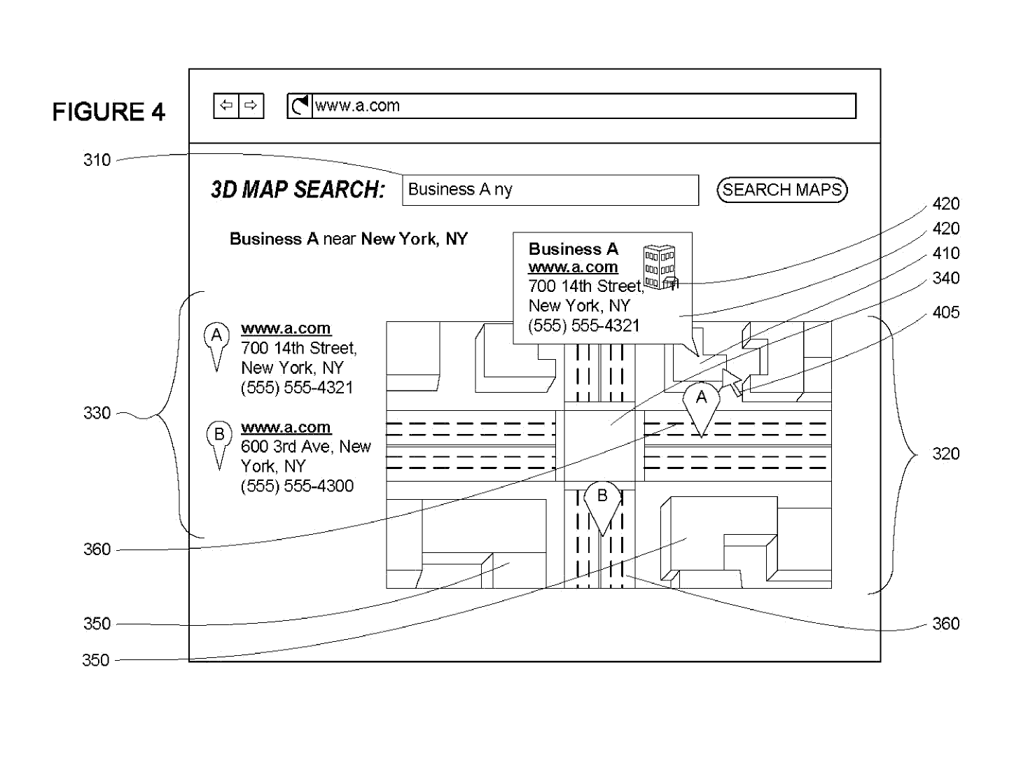

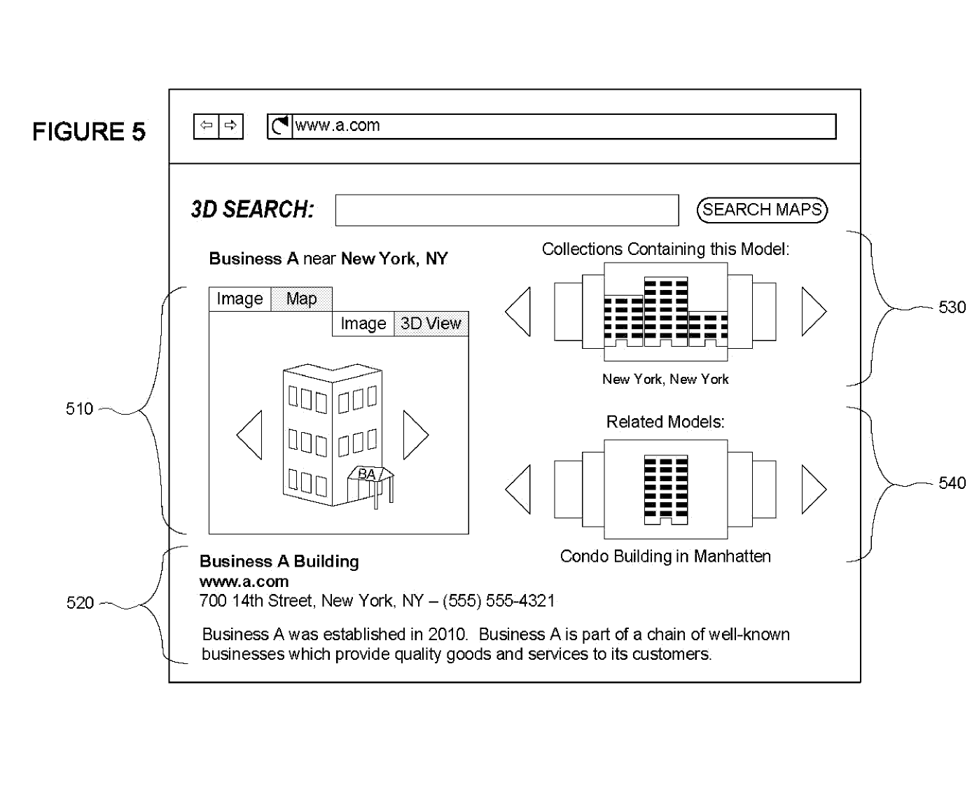

The user, by way of a client device, may access a 3D model. For example, the user's client device may transmit a request for a 3D map to the server. The request may identify a particular location. In response, the server may identify appropriate map information including one or more 3D objects. As shown in FIG. 3, the user may enter a search in search box 310 of the display on the user's client device. In response the server may provide a 3D map information 320 and search results 330 for display on the user's client device. The 3D map information may include 2D representations of some features, such as roads 360 and intersections 340, as well as 3D representations of other features, such as buildings 350. The user may then interact with the objects featured in the map. For example, as shown in FIG. 4, the user may maneuver a mouse icon 405 over and/or click on a building 410 and receive a popup 420 with a view of a 3D model. The user may also select model 410 by clicking on the model using mouse 405. In response, the user may be presented with a display of 3D model 510 and various other information as shown in FIG. 5.

In another example, rather than requesting map information, the user may access a database of 3D models. The user may query the database, for example, based on a location or attribute, and receive a list of search results. The user may select a particular search result in order to view more information about the object. For example, as shown in FIG. 5, the user may be provided with a display of model 510 as well as a description 520 of the model, the collections 530 containing the model, and other information such as related models 540 sharing similar features, etc. The user may also interact with the 3D model as described above.

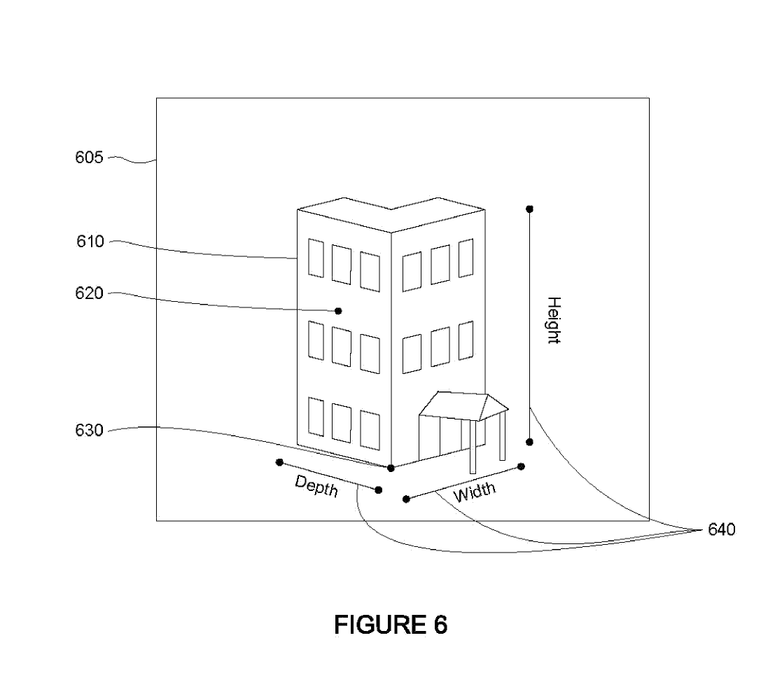

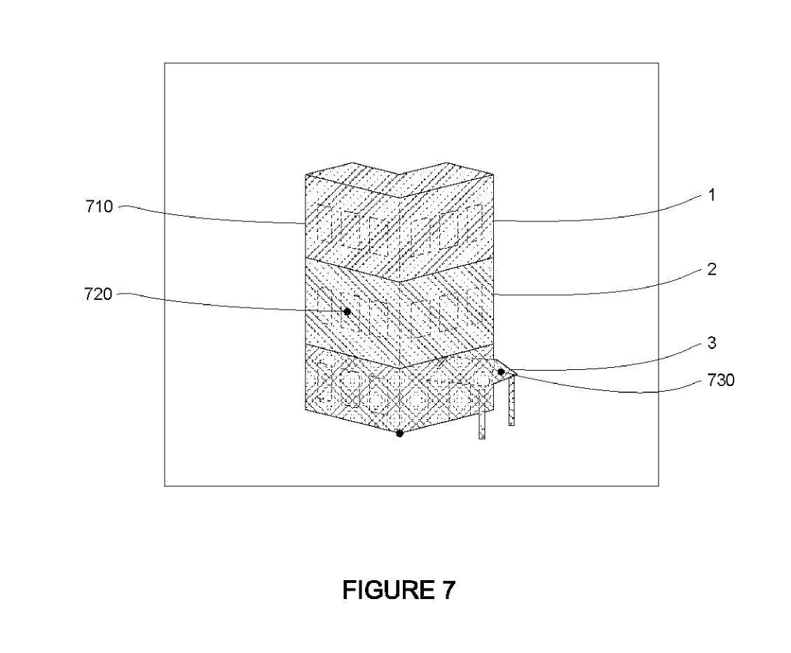

As noted above, the user may interact with the model, by zooming in or out to change the view of the object, click on the object, hovering over the object, etc. This interaction may be performed at the map level as shown in FIGS. 3 and 4 or on an individual model basis as shown in FIG. 5. For clarity and ease of understanding, the examples of FIGS. 6 and 7 described below are described with respect to a singular 3D model though it will be understood that this model may also be incorporated into a map, such as shown in FIGS. 3 and 4.

As the user interacts with the model, some information may be transmitted to the server. For example, when a user clicks on the object, the click event and the camera viewpoint information (or the angle of the user's view of the object) may be captured and transmitted to the server.

The server may project the click location onto the object, to identify its geolocation. For example, while viewing a 3D model of an object the user may click on the model. The server receives the orientation of the view of the 3D model, and projects the location of the click onto the object in the model. The object itself (for example a physical building) may be associated with a latitude and longitude pair as well as dimensional (height, width, and length) information. Using this information, the server may estimate the latitude, longitude, and altitude of a click location. As shown in FIG. 6, the user may click on model 610 at point 620 from a particular view point 605. It will be understood that the view point may be associated with a particular zoom level, orientation, and similar information. The server receives the click and the view point of the model and determines the actual location of the click on the model.

The server may then utilize the geographic location information and dimensional information associated with the object in the map information to determine the actual geographic location of the click (or rather the projected point). For example, the server may user the latitude and longitude coordinates at location 630 of the object as well as the height, width and depth information 640 to determine the geographic location of the click (or rather point 620).

In another example, the model may be divided into sections as shown in FIG. 7. In this example, the model is divided in to three sections, 1-3. When the user clicks on an area, the server may receive the location of the click and information identifying the viewpoint of the 3D at the time of the click. Rather than calculating latitude, longitude and altitude, the server may determine the geolocation of the click based on which of the sections received the click. For example, if a user clicks on a window 720 of model 710, the server may interpret the click as being within section 1. Similarly, if the user clicks on awning 730, the server may interpret the click as being within section 3. Alternatively, the server may calculate the latitude, longitude and altitude of the click as described with regard to FIG. 6 and determine whether it falls into one of the pre-determined sections of the 3D model as described with regard to FIG. 7. For example, a user may click on the clock tower of the San Francisco ferry terminal from ground level. Projecting the click onto the clock tower may identify a reference point or a particular location on the clock tower in which the user may be interested.

Once the server identifies the geolocation of the click location, the server may look up the click point in the content database to identify information associated with the point. The server may then generate targeted information for the site of the click event. For example, the user may interact with example building 610 or 710 of FIG. 6 or 7. If the user clicks on the top of the building, section 1, the server may return a coupon for a discount on a tour of a rooftop garden. If the user clicks on the base of the building, section 3, the server may display information about the history of the building. If the user clicks on the middle of the building, section 2, the server may identify which floor the click corresponds to and return business listing for an establishment on that floor.

Returning to the example of the clock tower, if the server has access to interesting information about the clock tower or information about the Ferry Terminal or surrounding areas, the server may provide it to the user's client device. In another example, if a user clicks on the base of a model of a ski lift, the server may provide lift ticket information and offer coupons. If the user clicks the same model at the top of the mountain, the server may provide advertisements for ski lessons, hot chocolate, or other discounts. If the user clicks on a beautiful view in the distance, the server may search for resorts with similar view and provide the results as travel recommendations to the user.

In yet another example, the user may click on the Thinker sculpture at Legion's of Honor in San Francisco. The server may identify that the user is interested in the Thinker and search for similar images containing the Thinker at the same location or at other locations. In some examples, the click may be used to produce revenue. For example, the server may provide a link to models or fine ink prints of the Thinker and collect a commission. Similarly, the server may provide advertisements of mini Thinker sculpture sales or a virtual Thinker for an online social persona. In another example, the server may search for and provide useful information about the sculpture to the user such as the history of the sculpture by Rodin, how the particular copy was acquired by the Legion, etc. In another example, if the user has examined a number of 3D models of objects within a given area, the server may provide content which considers more than one location. For example, if the user is exploring different models of the Golden Gate Bridge and Alcatraz in San Francisco, the serve may provide an automated tour of different hotspots around San Francisco.

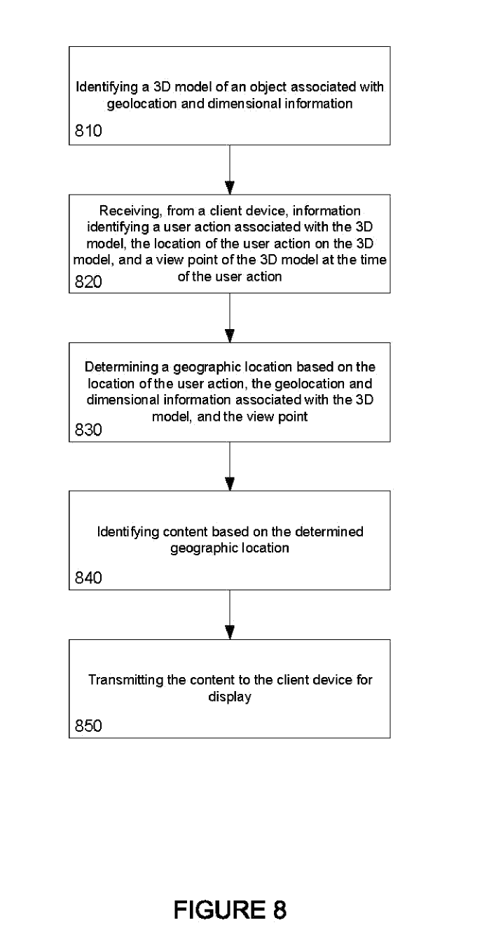

As shown in exemplary flow diagram 800 of FIG. 8, the server identifies a 3D model of an object associated with geolocation information at block 810. As described above, this identification may be based on the server having previously provided the 3D model to the user. Alternatively, the 3D model may be identified based on information received from a client device (for example, as part of the information received from the client device at block 820). As shown in block 820, the server receives from the client device information identifying a user action associated with the 3D model. The received information also identifies the location of the user action on the 3D model and a view point (such as a camera angle, orientation, and position) of the 3D model at the time of the user action. At block 830, the server determines a geographic location based on the location of the user action, the geolocation and dimensional information associated with the 3D model, as well as the view point. Next the server identifies content based on the determined geographic location. The server then transmits the content to the client device for display to a user.

Although the examples above identify the user interaction as “clicks,” it will be understood that other types of actions may be identified, their locations transmitted to the server and used to identify content. For example, if a user hovers over an object for an extended period, such as to read a popup as shown in FIG. 4, the location of the hover on the object may be transmitted to the server and used to identify content.

Based on the geographical and physical location of the user interaction, the server may also identify user interest in a model and the model's geographic location. For example, the server may determine the amount of interaction users have with each area of a particular 3D model based on the number of clicks or the amount of time spent viewing a particular angle. The server stores the click and view information and may use the user information to identify whether the user's interest in an object is fleeting or sustained, and to identify relevant content. For example, if the server receives information indicating that users are hovering (e.g., with a mouse icon) over a model for an extended period of time or receives frequent clicks, the server may determine that the geographic area and/or model(s) associated with the activity are actually interesting to users. The server may use this feedback and perform more fine grained division of the model or models in the area. The server may also be automated to perform more detailed image analysis in the geographic area of the model. In some examples, where users are generating content (for example by uploaded the 3D models), the server may request feedback, such as “do you like this?” or “why is this interesting?” from other uses who view the model.

Preferably, privacy protections are provided for any data regarding a user's actions including, for example, anonymization of personally identifiable information, aggregation of data, filtering of sensitive information, encryption, hashing or filtering of sensitive information to remove personal attributes, time limitations on storage of information, or limitations on data use or sharing. Preferably, data is anonymized and aggregated such that individual user data is not revealed.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A computer-implemented method for providing content for display to a user, the method comprising:
identifying a 3D model of an object associated with geolocation information and dimensional information;
receiving, from a client device, information identifying a user action and a location of the user action on the 3D model;
determining, by a processor, a geographic location based on the location of the user action on the 3D model, the geolocation information and the dimensional information;
identifying content based on the geographic location; and
transmitting the content to the client device for presentation to the user.

2. The method of claim 1, wherein the object is a building.

3. The method of claim 1, wherein the information identifying a user action is a click on the 3D model.

4. The method of claim 1, wherein the geographic location is a section of the 3D model or the object and the content is identified based on the section.

5. The method of claim 1, wherein the content is an advertisement.

6. The method of claim 1, wherein the information identifying the location of the user action includes a orientation of the 3D model at a time of the user action.

7. The method of claim 1, wherein the geolocation information includes position coordinates and the dimension information includes one or more of height, width, and depth information of the object.

8. The method of claim 1, further comprising:
in response to receiving the information identifying a user action, transmitting a request for user input;
receiving the user input; and
storing the user input with other received input in memory accessible by the processor.

9. The method of claim 8, wherein the content is identified based on the other received input.

10. The method of claim 8, further comprising:
using the stored user input and the other received input to divide the 3D model or the object into two or more sections; and
identifying a section of the two or more sections based on the received information identifying a user action and a location of the user action on the 3D model;
wherein identifying the content is further based on the identified section.

11. A computer comprising:
a processor;
memory accessible by the processor; and
the processor being operable to:
identify a 3D model of an object associated with geolocation information and dimensional information;
receive, from a client device, information identifying a user action and a location of the user action on the 3D model;
determine a geographic location based on the location of the user action on the 3D model, the geolocation information and the dimensional information;
identify content based on the geographic location; and
transmit the content to the client device for presentation to the user.

12. The computer of claim 11, wherein the object is a building.

13. The computer of claim 11, wherein the information identifying a user action is a click on the 3D model.

14. The computer of claim 11, wherein the geographic location is a section of the 3D model or the object and the content is identified based on the section.

15. The computer of claim 11, wherein the content is an advertisement.

16. The computer of claim 11, wherein the information identifying the location of the user action includes an orientation of the 3D model at a time of the user action.

17. The computer of claim 11, wherein the geolocation information includes position coordinates and the dimension information includes one or more of height, width, and depth information of the object.

18. The computer of claim 11, wherein the processor is further operable to:
in response to receiving the information identifying a user action, transmit a request for user input; receive the user input; and
store the user input with other received input in memory accessible by the processor.

19. The computer of claim 18, wherein the content is identified based on the other received input.

20. The computer of claim 18, wherein the processor is further operable to:
use the stored user input and the other received input to divide the 3D model or the object into two or more sections; and
identify a section of the two or more sections based on the received information identifying a user action and a location of the user action on the 3D model;
wherein the content is identified based on the identified section.
